(19) United States
(12) Patent Application Publication
(10) Pub. No.: US 2014/0050422 A1
(43) Pub. Date: Feb. 20, 2014

(54) Electronic Apparatus and Image Processing Method

(71) Applicant: Kabushiki Kaisha Toshiba, Tokyo (JP)

(72) Inventors: Kohei Momosaki, Mitaka-shi (JP); Kouetsu Wada, Nishitama-gun (JP); Kenichi Tabe, Ome-shi (JP); Tomonori Sakaguchi, Ome-shi (JP)

(73) Assignee: Kabushiki Kaisha Toshiba, Tokyo (JP)

(21) Appl. No.: 14/062,792

(22) Filed: Oct. 24, 2013

Related U.S. Application Data
(63) Continuation of application No. 13/162,465, filed on Jun. 16, 2011.

(30) Foreign Application Priority Data
Oct. 29, 2010 (JP) 2010-244301

(51) Int. Cl. G06F 17/30

(52) U.S. Cl. CPC G06F 17/30265
USPC 382/305

(57) ABSTRACT

According to one embodiment, an electronic apparatus comprises a specific date setting module configured to set an input date along with an image setting module, an image extraction module and an image display module. The image setting module associates a still image with the specific date. The image extraction module extracts still images when a present date is within a first time period comprising the specific date, the extracted still images comprising at least a still image which is relevant to the date and time. The image display module displays a moving picture using the extracted still images, where the moving picture being different with respect to at least one of a length of the moving picture, a combination of still images used in the moving picture, and an effect used in the moving picture, on a day-by-day basis within the first time period.

### CROSS-REFERENCE TO RELATED APPLICATIONS

This application is a continuation of U.S. patent application Ser. No. 13/162,465, filed Jun. 16, 2011, which is based upon and claims the benefit of priority from Japanese Patent Application No. 2010-244301, filed Oct. 29, 2010; the entire contents of both of which are incorporated herein by reference.

### FIELD

Embodiments described herein relate generally to an electronic apparatus which displays an image, and an image processing method which is applied to the electronic apparatus.

### BACKGROUND

In recent years, various electronic apparatuses, such as a personal computer, a digital camera and a PDA, have been gaining in popularity. Such an electronic apparatus has a function of managing still images, e.g. photos. As an image management method, there is known a method of classifying photos into a plurality of groups, based on photography (generated) date/time data which is added to the photos.

In addition, recently, attention has been paid to a technique for creating a moving picture (e.g. photo-movie, slideshow, etc.) by using still images such as photos. As the technique, for example, there is known a technique which selects still images from a plurality of still images, the selected still images having photography date/time data corresponding to a designated date, and then successively displays the selected still images.

However, in the technique of displaying still images corresponding to the designated date, the still images that are to be displayed are limited to the still images having the photography date/time data corresponding to the designated date. It is thus difficult to present to the user a moving picture including, for example, still images which were not photographed on the same date but have high relevance, or unexpected still images (still images of which the user is unaware). In addition, it is difficult to present a moving picture including still images which are appropriate for an anniversary (a commemoration day) since the anniversary is generally associated with not only the date but also a specific event or a specific person.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is an exemplary block diagram showing the system configuration of the electronic apparatus of the embodiment.

FIG. 3 is an exemplary block diagram showing the functional structure of a photo-movie creation application program which is executed by the electronic apparatus of the embodiment.

FIG. 4 shows an example of index information which is used by the photo-movie creation application program which is executed by the electronic apparatus of the embodiment.

FIG. 5 shows an example of anniversary data which is used by the photo-movie creation application program which is executed by the electronic apparatus of the embodiment.

FIG. 6 shows an example of an anniversary setting screen which is displayed by the electronic apparatus of the embodiment.

FIG. 7 shows another example of the anniversary setting screen which is displayed by the electronic apparatus of the embodiment.

FIG. 8 shows still another example of the anniversary setting screen which is displayed by the electronic apparatus of the embodiment.

FIG. 9 is an exemplary flowchart illustrating an example of the procedure of an indexing process which is executed by the electronic apparatus of the embodiment.

FIG. 10 is an exemplary flowchart illustrating an example of the procedure of an anniversary setting process which is executed by the electronic apparatus of the embodiment.

FIG. 11 is an exemplary flowchart illustrating an example of the procedure of a moving picture playback process which is executed by the electronic apparatus of the embodiment.

### DETAILED DESCRIPTION

Various embodiments will be described hereinafter with reference to the accompanying drawings.

In general, according to one embodiment, an electronic apparatus includes an anniversary setting module, an image setting module, an image extraction module, and an image extraction module. The anniversary setting module sets an input date to be an anniversary. The image setting module associates one still image of a plurality of still images with the anniversary, the associated still image being designated by a user. The image extraction module extracts still images from the plurality of still images when a present date is within a predetermined time period including the anniversary, the extracted still images being relevant to the associated still image. The image display module displays a moving picture using the associated still image and the extracted still images.

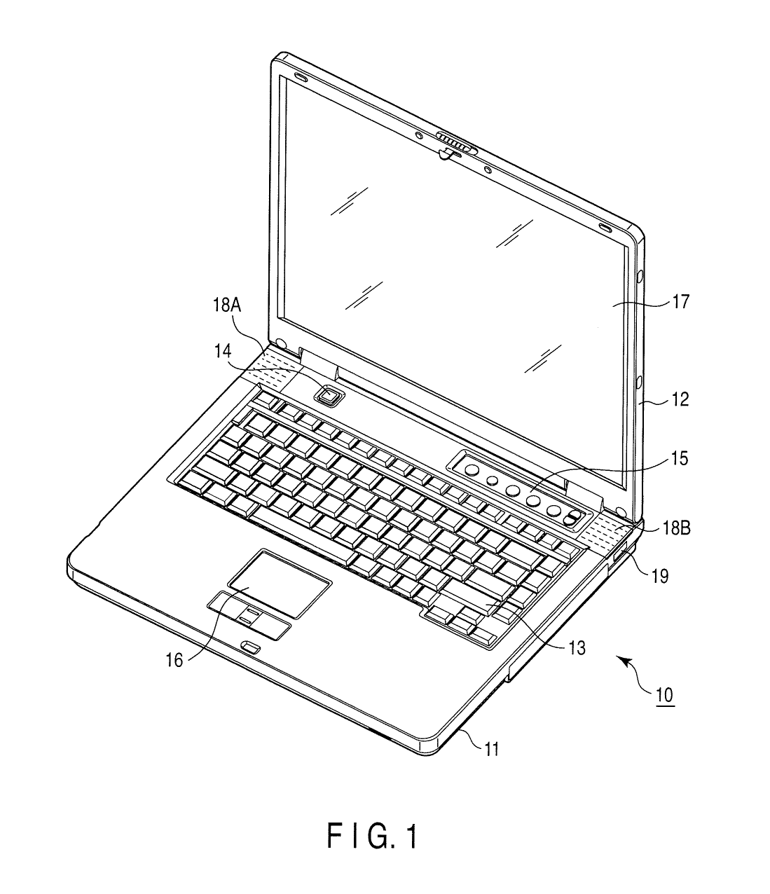

FIG. 1 is a perspective view showing the external appearance of an electronic apparatus according to an embodiment. The electronic apparatus is realized, for example, as a notebook-type personal computer 10. As shown in FIG. 1, the computer 10 includes a computer main body 11 and a display unit 12. A liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a touch pad 16, and speakers 18A and 18B are disposed on the top surface of the housing of the computer main body 11. Various operation buttons are provided on the input operation panel 15.

The right side surface of the computer main body 11 is provided with a universal serial bus (USB) connector 19 for connection to a USB cable or a USB device of, e.g. the USB 2.0 standard.

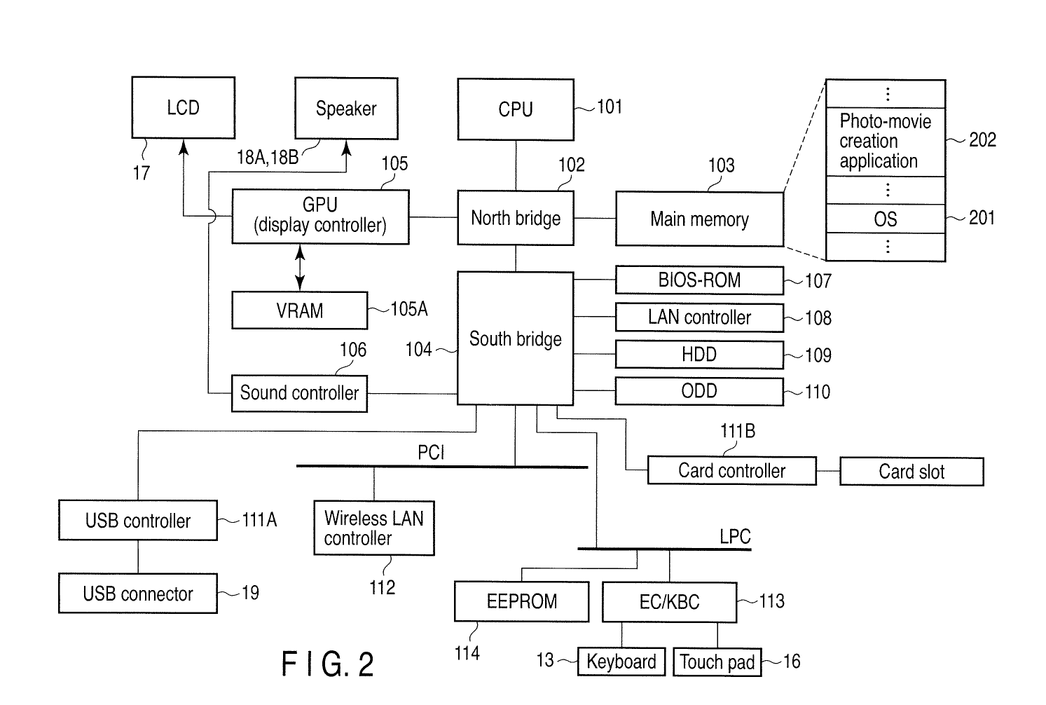

FIG. 2 shows the system configuration of the computer 10.

The computer 10, as shown in FIG. 2, includes a central processing unit (CPU) 101, a north bridge 102, a main memory 103, a south bridge 104, a graphics processing unit (GPU) 105, a video random access memory (VRAM) 105A, a sound controller 106, a basic input/output system-read only memory (BIOS-ROM) 107, a local area network (LAN) controller 108, a hard disk drive (HDD) 109, an optical disc drive (ODD) 110, a USB controller 111A, a card controller 111B, a wireless LAN controller 112, an embedded controller/keyboard controller (EC/KBC) 113, and an electrically erasable programmable ROM (EEPROM) 114.

The CPU 101 is a processor for controlling the operations of the respective components in the computer 10. The CPU 101 executes an operating system (OS) 201 and various application programs, such as a photo-movie creation application program 202, which are loaded from the HDD 109 into the main memory 103. The photo-movie creation application program 202 is software which plays back various digital content data (e.g. photo-movie) which are stored in, e.g. the HDD 109. The photo-movie creation application program 202 has a moving picture generation function. The moving picture generation function is a function of creating a composite moving picture (movie) by using digital contents (materials) such as photos stored in, e.g. the HDD 109. Further, the moving picture generation function includes a function of analyzing the contents which are used for the moving picture. The photo-movie creation application program 202 displays a moving picture on the screen (LCD 17) by playing back the moving picture which is created by using the contents.

In addition, the CPU 101 executes a BIOS that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the GPU 105 via, e.g. a PCI EXPRESS serial bus.

The GPU 105 is a display controller which controls the LCD 17 that is used as a display monitor of the computer 10. A display signal, which is generated by the GPU 105, is sent to the LCD 17.

The south bridge 104 controls devices on a peripheral component interconnect (PCI) bus and devices on a low pin count (LPC) bus. The south bridge 104 includes an integrated drive electronics (IDE) controller for controlling the HDD 109 and ODD 110. The south bridge 104 also has a function of communicating with the sound controller 106.

The sound controller 106 is a sound source device and outputs audio data, which is a playback target, to the speakers 18A and 18B. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard. The USB controller 111A executes communication with an external device which supports, e.g. the USB 2.0 standard. The external device is connected via the USB connector 19. For example, the USB controller 111A is used in order to receive an image data file which is stored in, for example, a digital camera. The card controller 111B executes data write and data read in/from a memory card such as an SD card, which is inserted in a card slot provided in the computer main body 11.

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

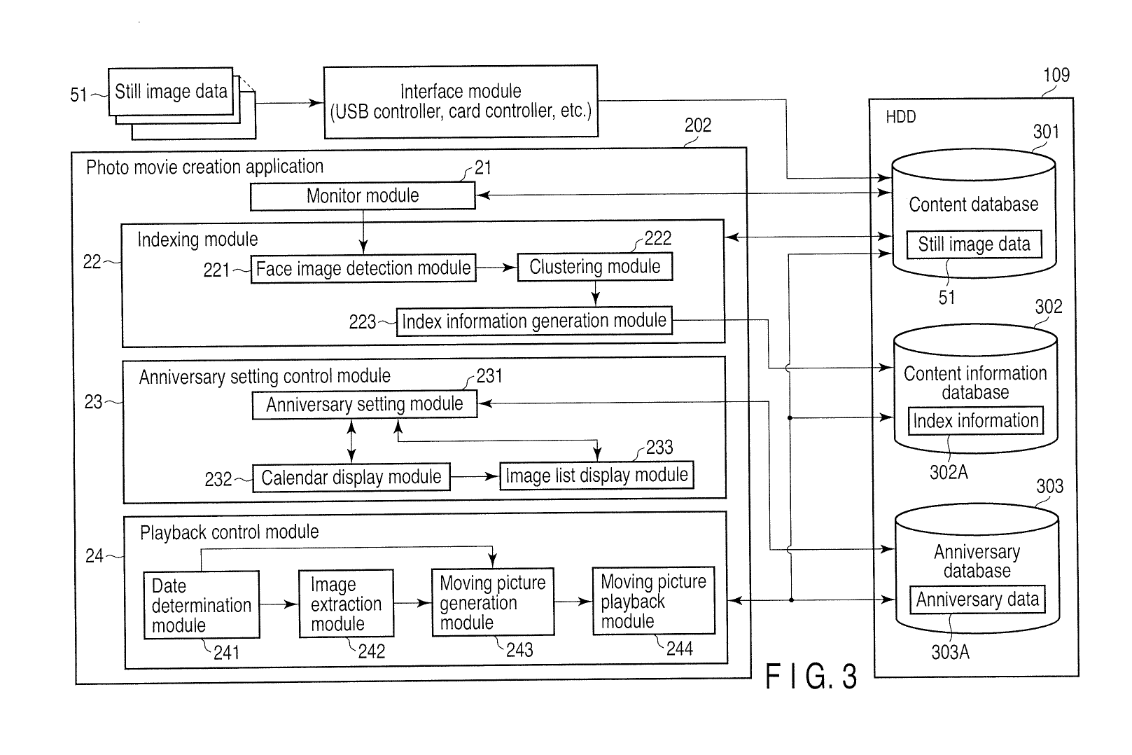

Next, referring to FIG. 3, a functional structure of the photo-movie creation application program 202 is described. A description is given of a structure example for realizing a moving picture generation function, which is one of the functions of the photo-movie creation application program 202. The moving picture generation function is a function for creating a moving picture (e.g. photo-movie, slideshow) by using still images (still image data) 51 stored in a predetermined directory (content database 301) in the HDD 109, and playing back the created moving picture. The still images 51 are, for instance, digital photos, or other various still images (e.g. JPEG files). The term “photo-movie” refers to a moving picture (movie) which is generated by using still images (e.g. photos). In the playback of the photo-movie, various effects or transitions are applied to the still images. The still images, to which the effects or transitions have been applied, are played back together with music. The photo-movie creation application program 202 may automatically extract still images which are relevant to a certain still image (key image), and may create and play back the photo-movie by using the extracted still images. In addition, the photo-movie creation application program 202 may create and play back a slideshow by using the extracted still images. The term “slideshow” refers to a moving picture (movie) which successively displays the still images one by one. The photo-movie is also referred to as an intelligent slideshow.

The photo-movie creation application program 202 monitors the directory (photo folder) in the HDD 109, which is set by the user. If the photo-movie creation application program 202 detects that one or more new still images (photo files) have been stored in the photo folder, the photo-movie creation application program 202 executes indexing of the one or more new still images.

The creation of the photo-movie is executed based on, for example, a still image (also referred to as a key image). Specifically, still images relevant to a selected key image are automatically extracted, and a photo-movie is created by using the extracted still images. A style, an audio (music) and a person (face) of interest can be designated as a condition for creating a photo-movie. According to the selected style, a still image extraction scheme to be used and an effect/transition to be used are determined. In the prior art, photos which are used in creating a movie are designated by the user. On the other hand, the photo-movie creation application program 202 automatically extracts photos, which are to be used, from all still images in the photo folder. Thereby, unexpected photos can be found and shown to the user.

In the extraction process, photos with better photographic quality may be extracted according to the smile degree of face images, the sharpness of face images, etc. In addition, for example, photos including face images of the selected person, or photos including face images of another person who has relevance to the selected person may be extracted by recognizing persons corresponding to face images by using face clustering.

In addition, the photo-movie creation application program 202 has a function of setting an anniversary, and playing back a moving picture which is suited to the anniversary, when the present date is within a predetermined time period including the set anniversary. Specifically, the photo-movie creation application program 202 may automatically display, on a pre-registered anniversary (or in a time period including a pre-registered anniversary), a slideshow or a photo-movie, which is suited to the anniversary. Thereby, the photo-movie creation application program 202 can notifies the user that the anniversary is drawing near, and can presents a moving picture which makes the anniversary enjoyable and exciting.

The photo-movie creation application program 202 includes a monitor module 21, an indexing module 22, an anniversary setting control module 23, and a playback control module 24.

The monitor module 21 determines whether a new still image 51 has been stored in the content database 301 in the HDD 109 via an interface such as the USB controller 111A or card controller 111B by monitoring the content database 301. The content database 301 corresponds to a predetermined directory (the above-described photo folder) in the HDD 109. The still image 51 stored in the content database 301 is used as a content candidate of a composite moving picture (photo-movie, slideshow). Not only the still images 51, but also a moving picture, such as a short movie, may be stored as a content candidate in the content database 301. The monitor module 21 notifies the indexing module 22 that the new still image 51 has been stored in the HDD 109.

In response to the notification from the monitor module 21, the indexing module 22 analyzes the still images 51 newly stored in the content database 301, and then generates index information 302A indicative of attributes of the still images 51. The indexing by the indexing module 22 is triggered by, for example, the storing of one or more new still images (photo files) in the content database 301. In other words, when one or more new still images have been stored in the content database 301, the indexing module 22 generates the index information 302A corresponding to the new still image(s).

The indexing module 22 has a face recognition function. The index information 302A also includes a recognition result of face images included in the still images 51.

The indexing module 22 includes a face image detection module 221, a clustering module 222, and an index information generation module 223.

The face image detection module 221 detects a face image (face images) from the still image 51 that is a target of indexing (e.g. a still image newly stored in the photo folder). The face image may be detected, for example, by analyzing the features of the still image 51 and searching for a region having a feature similar to a face image feature sample which is prepared in advance. The face image feature sample is characteristic data which is obtained by statistically processing face image features of many persons. By the face detection process, the region corresponding to the face image included in the still image 51 is detected, and then the position (coordinates) and size of the region are detected.

In addition, the face image detection module 221 analyzes the detected face image. The face image detection module 221 calculates, for example, the smile degree, sharpness, frontality, etc. of the detected face image. The smile degree is an index indicative of the degree of a smile of the detected face image. The sharpness is an index indicative of the degree of sharpness of the detected face image (e.g. non-blurredness). The frontality is an index indicative of the degree at which the detected face image is directed to the front side.

The face image detection module 221 outputs the information indicative of the detected face image(s) to the clustering module 222.

The clustering module 222 classifies the detected face image(s) on a person-by-person basis by subjecting the detected face image(s) to a clustering process. Based on the processing result, the clustering module 222 allocates identification information (person identifier) of the person corresponding to the face image. The clustering module 222 outputs the information indicative of the face image and the attributes of the face image (the smile degree, sharpness, frontality, person ID), to the index information generation module 223.

The index information generation module 223 generates the index information 302A, based on the processing results by the face image detection module 221 and clustering module 222. The index information generation module 223 stores the generated index information 302A in a content information database 302.

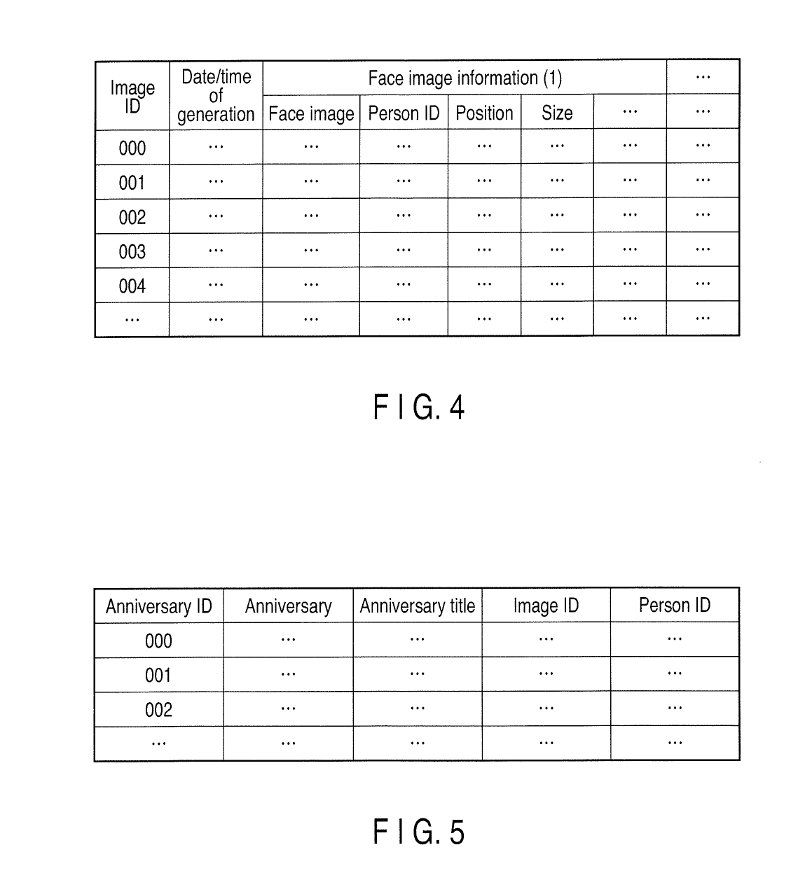

FIG. 4 shows a structure example of the index information 302A. The index information 302A includes a plurality of entries corresponding to the still images 51. Each entry includes an image ID, a date/time of generation (date/time of photography), and face image information. In the entry corresponding to a certain still image, the “image ID” is indicative of identification information which is unique to the still image. The “date/time of generation” is indicative of the date/time of generation of the still image (the date/time of photography). As the “date/time of generation”, for example, the information added to the still image data is used. The “face image information” includes, for example, a face image (e.g. the location of storage of data corresponding to the face image), person ID, position, size, smile degree, sharpness, and frontality. When the still image includes a plurality of face images, the index information 302A includes face image information corresponding to each of the face images. In addition, the index information 302A may include information indicative of the location where the still image was generated.

By the above-described structure, the indexing module 22 can generate the index information 302A corresponding to the still image 51 that is the indexing target, and can store the generated index information 302A in the content information database 302.

The anniversary setting control module 23 sets an input date to be an anniversary. In addition, the anniversary setting control module 23 associates a still image and/or a person (main character) with the anniversary by using the index information 302A. The associated still image and/or the associated person is designated by the user. The anniversary setting control module 23 includes an anniversary setting module 231, a calendar display module 232 and an image list display module 233.

The anniversary setting module 231 displays an anniversary setting screen for setting an anniversary on the LCD 17. In addition, the anniversary setting module 231 stores anniversary data 303A indicative of the set anniversary in an anniversary database 303. The anniversary is designated by, e.g. the user.

The calendar display module 232 displays a calendar screen for selecting the date of an anniversary. The anniversary setting module 231 sets a date, which has been selected by using the calendar screen, to be an anniversary.

In addition, the image list display module 233 displays a photo selection screen for selecting a still image which is appropriate for an anniversary. For example, the image list display module 233 displays the photo selection screen including a list of still images (still image data) 51 stored in the content database 301. The anniversary setting module 231 associates a still image, which has been selected by using the photo selection screen, with the anniversary. Besides, the image list display module 233 may also display, for example, a photo selection screen including a list of face images of persons appearing in the still images 51 stored in the content database 301. The anniversary setting module 231 associates a person (main character), who has been selected by using the photo selection screen, with the anniversary.

FIG. 5 shows a structure example of the anniversary data 303A. The anniversary data 303A includes a plurality of entries corresponding to a plurality of anniversaries. Each entry includes an anniversary ID, an anniversary, an anniversary title, an image ID, and a person ID. In the entry corresponding to a certain anniversary, the “anniversary ID” is indicative of identification information unique to the anniversary. The “anniversary” is indicative of the date of the anniversary. In the “anniversary”, for example, a month and a day are set (e.g. October 21). In the meantime, a year, a month and a day may be set in the “anniversary” (e.g. Mar. 5, 2002). The “anniversary title” is indicative of the name of the anniversary. In the “anniversary title”, for example, “birthday of XX”, “wedding anniversary” or “New Year's Day” is set. The “image ID” is indicative of an image ID of an image which is associated with the anniversary. The “person ID” is indicative of a person ID of a person (main character) who is associated with the anniversary.

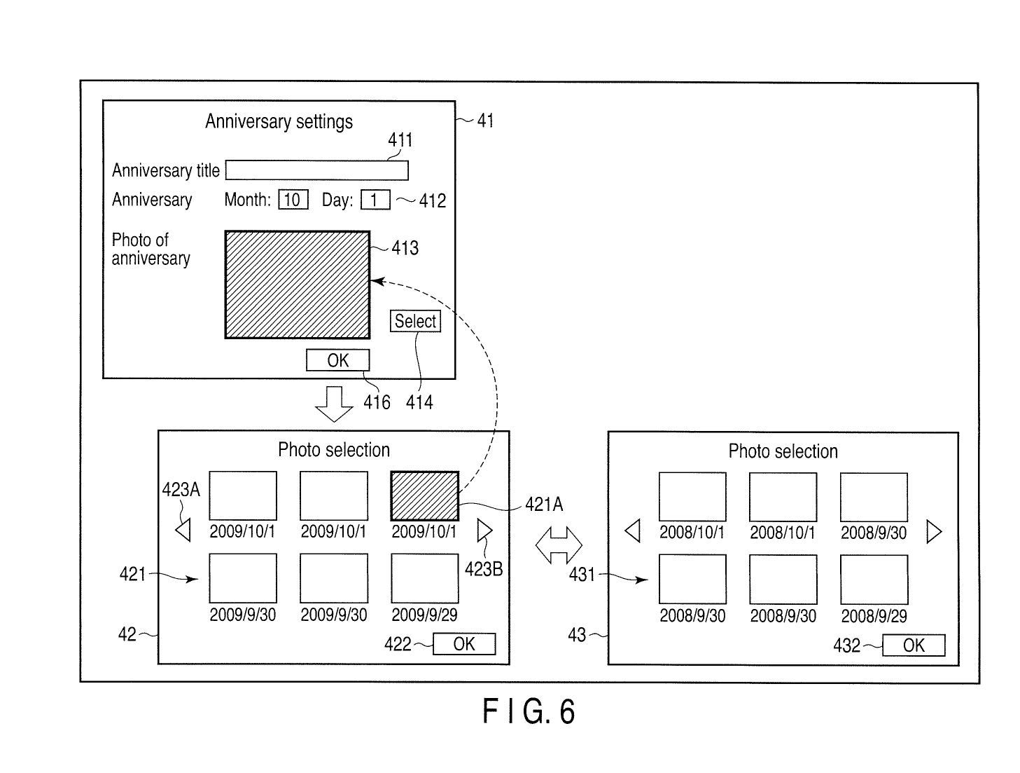

FIGS. 6, 7 and 8 illustrate examples of the screen for setting information indicative of an anniversary.

FIG. 6 shows an example of setting information indicative of an anniversary by using an anniversary setting screen 41 and photo selection screens 42 and 43. In the example shown in FIG. 6, to begin with, the anniversary setting screen 41 is displayed by the anniversary setting module 231. The anniversary setting screen 41 includes an anniversary title input area 411, an anniversary input area 412, a photo display area 413, an image selection button 414, and an “OK” button 416. The anniversary title input area 411 is an area for inputting the title of an anniversary. The anniversary input area 412 is an area for inputting the date of the anniversary. The photo display area 413 is a preview area for displaying an image which is to be associated with the anniversary. The image selection button 414 is a button for instructing display of the photo selection screen 42. The “OK” button 416 is a button for instructing the completion of the setting of the anniversary.

The user inputs information indicative of the anniversary by using the anniversary setting screen 41. Specifically, the user inputs the title of the anniversary in the anniversary title input area 411. In addition, the user inputs the date (e.g. October 1) of the anniversary in the anniversary input area 412. Then, the user instructs the display of the photo selection screen 42 by pressing the image selection button 414. The image list display module 233 displays the photo selection screen 42 in response to the pressing of the image selection button 414.

The photo selection screen 42 includes an image list display area 421 and an “OK” button 422. The image list display area 421 is an area for displaying a list of thumbnail images showing candidates of images which are to be associated with the anniversary. The “OK” button 422 is a button for instructing the completion of the image selection.

The image list display module 233 displays the photo selection screen 42 including a list of still images (thumbnail images) having the date information corresponding to the date of the anniversary, when the date of the anniversary has already input to the anniversary input area 412 (anniversary setting screen 41). For example, when the date “October 1” is input to the anniversary input area 412, the image list display module 233 extracts those still images from the still images 51 stored in the content database 301, which have date information of “October 1” or date information near the date of “October 1”. Then, the image list display module 233 displays a list of thumbnail images indicative of the extracted still images in the image list display area 421. The list of the thumbnail images indicative of the extracted still images is displayed, for example, on a year-by-year basis. For example, the image list display area 421 (photo selection screen 42) of FIG. 6 displays a list of images having the date information of “Oct. 1, 2009”, “Sep. 30, 2009” and “Sep. 29, 2009”.

In the image list display area 421, the number of thumbnail images, which can be displayed at a time, is limited. Thus, the thumbnail images, which are displayed in the image list display area 421, may be scrolled by using a scroll button 423A which is disposed at the left end of the image list display area 421, and a scroll button 423B which is disposed at the right end of the display area 421. For example, in response to the pressing of the scroll button 423A, the image list display module 233 displays, in the image list display area 421, a list of images which were photographed (generated) in a year preceding the year corresponding to the currently displayed images. In addition, for example, in response to the pressing of the scroll button 423B, the image list display module 233 displays, in the image list display area 421, a list of images which were photographed (generated) in a year following the year corresponding to the currently displayed images. In the example of FIG. 6, in response to the pressing of the scroll button 423B, the photo selection screen 42 transitions to the photo selection screen 43. Specifically, in response to the pressing of the scroll button 423B, the image list display module 233 displays the photo selection screen 43 including an image list display area 431 which displays a list of images having the date information of “Oct. 1, 2008” and “Sep. 30, 2008”. In the meantime, the image list display module 233 may scroll-display other images photographed in the same year, in response to the pressing of the scroll button 423A, 423B.

The user selects a still image, which is to be associated with the anniversary, by using the photo selection screen 42. Specifically, the user selects one image 421A, which is to be associated with the anniversary, from among a plurality of still images displayed in the image list display area 421. The selected still image is a still image which is representative of the anniversary, for instance, a photo including the main character of the anniversary. After selecting the single image 421A which is to be associated with the anniversary, the user presses the “OK” button 422, thereby instructing the completion of the image selection. In response to the pressing of the “OK” button 422, the image list display module 233 outputs an image ID corresponding to the selected image 421A to the anniversary setting module 231.

The anniversary setting module 231 displays (preview-displays) the selected image corresponding to the output image ID in the photo display area 413. After inputting necessary information for setting the anniversary by using the anniversary setting screen 41, the user presses the “OK” button 416, thereby instructing the completion of the input. In response to the pressing of the “OK” button 416, the anniversary setting module 231 generates anniversary data 303A based on the input information. Specifically, the anniversary setting module 231 generates anniversary data 303A including the anniversary title which has been input to the anniversary title input area 411, the date of the anniversary which has been input to the anniversary input area 412, and the still image 421A (image ID) which has been associated with the anniversary. Thereby, the still image 421A, which has been selected by the user, is associated with the anniversary. The anniversary setting module 231 stores the generated anniversary data 303A in the anniversary database 303.

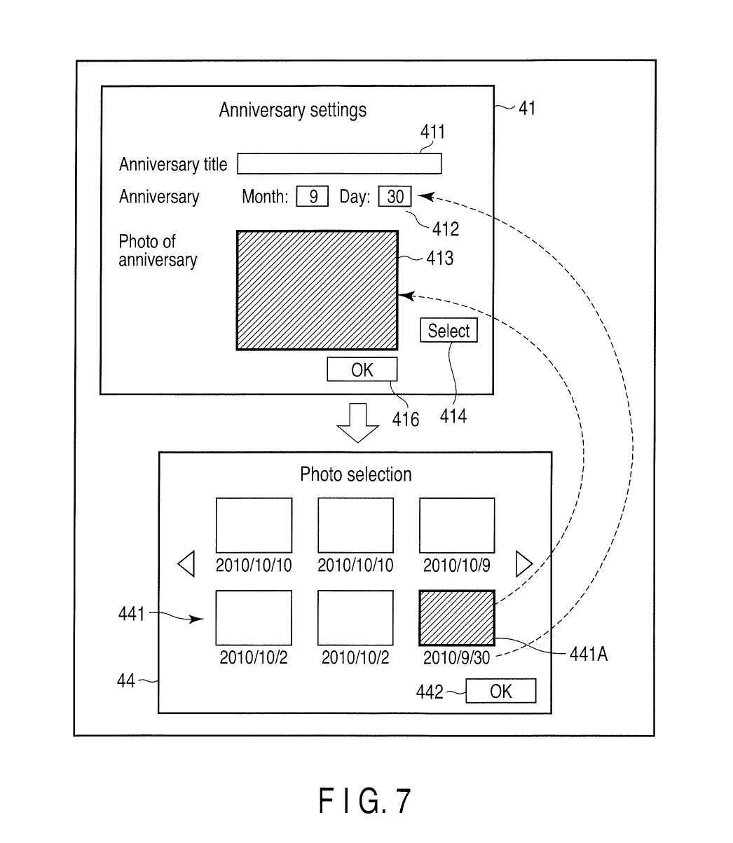

FIG. 7 shows another example of setting the information indicative of the anniversary, by using the anniversary setting screen 41 and a photo selection screen 44. The anniversary setting screen 41 and photo selection screen 44 shown in FIG. 7 have the same structure as the anniversary setting screen 41 and photo selection screen 42 shown in FIG. 6.

The user inputs information indicative of the anniversary by using the anniversary setting screen 41. Specifically, the user inputs the title of the anniversary to the anniversary title input area 411. Then, the user instructs the display of the photo selection screen 44 by pressing the image selection button 414. The image list display module 233 displays the photo selection screen 44 in response to the pressing of the image selection button 414.

When the date of the anniversary is not input to the anniversary input area 412 (anniversary setting screen 41), the image list display module 233 displays a list of predetermined images (thumbnail images) (e.g. a list of images having the date information corresponding to the present date) in an image list display area 441. For example, when the present date is “October 10”, the image list display module 233 extracts those still images from the still images 51 stored in the content database 301, which have date information of “October 10” or date information near the date of “October 10”. Then, the image list display module 233 displays a list of thumbnail images indicative of the extracted still images in the image list display area 441. The list of the thumbnail images indicative of the extracted still images is displayed, for example, on a year-by-year basis. For example, the image list display area 441 (photo selection screen 44) of FIG. 7 displays a list of images having the date information of “Oct. 10, 2010”, “Oct. 9, 2010”, “Oct. 2, 2010” and “Sep. 30, 2010”.

The user selects an image, which is representative of the anniversary that is to be set, by using the photo selection screen 44. Specifically, the user selects one image 441A, which is representative of the anniversary, from among a plurality of images displayed in the image list display area 421. The selected image is an image which is representative of the anniversary, for instance, a photo including the main character of the anniversary. After selecting the single image 441A which is representative of the anniversary, the user instructs the completion of the image selection by pressing an “OK” button 442. In response to the pressing of the “OK” button 442, the image list display module 233 outputs an image ID corresponding to the selected image 441A to the anniversary setting module 231.

Based on the image ID output by the image list display module 233, the anniversary setting module 231 sets (displays) the date corresponding to the selected image 441A in the anniversary input area 412. The date corresponding to the selected image 441A is, for example, the date of photography of the image or the date of generation of the image. In the anniversary setting screen 41 shown in FIG. 7, the date “September 30” corresponding to the image 441A, which has been selected by using the photo selection screen 44, is set in the anniversary input area 412. In addition, based on the image ID which has been output by the image list display module 233, the anniversary setting module 231 previews the selected image 441A in the photo display area 413. In the meantime, the user can change the date which has been set in the anniversary input area 412. After inputting necessary information for setting the anniversary by using the anniversary setting screen 41, the user instructs the completion of the input by pressing the “OK” button 416. In response to the pressing of the “OK” button 416, the anniversary setting module 231 generates anniversary data 303A based on the input information. Specifically, the anniversary setting module 231 generates anniversary data 303A including the anniversary title which has been input to the anniversary title input area 411, the date of the anniversary which has been input to the anniversary input area 412, and the still image 441A (image ID) which has been associated with the anniversary. Thereby, the still image 441A, which has been selected by the user, is associated with the anniversary. The anniversary setting module 231 stores the generated anniversary data 303A in the anniversary database 303.

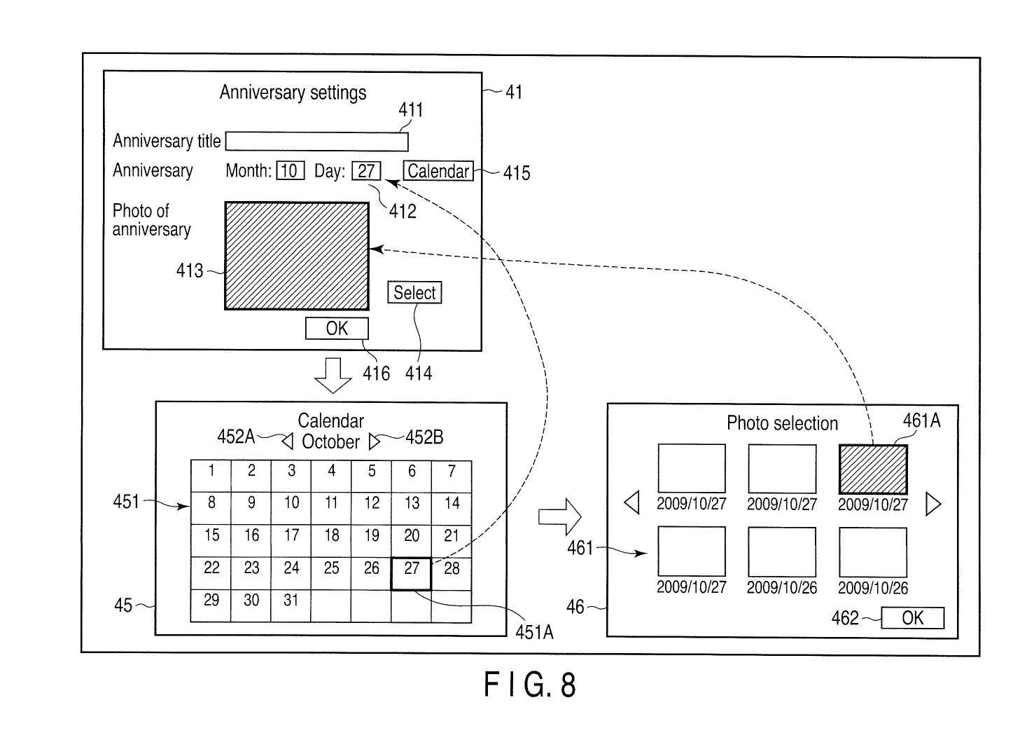

FIG. 8 shows another example of setting the information indicative of the anniversary, by using the anniversary setting screen 41, a calendar screen 45 and a photo selection screen 46. The anniversary setting screen 41 shown in FIG. 8 further includes a calendar display button 415. The photo selection screen 46 has the same structure as the photo selection screen 42 shown in FIG. 6.

The user inputs information indicative of the anniversary by using the anniversary setting screen 41. Specifically, the user inputs the title of the anniversary to the anniversary title input area 411. Then, the user instructs the display of the calendar screen 45 by pressing the calendar display button 415. In response to the pressing of the calendar display button 415, the calendar display module 232 displays the calendar screen 45.

The calendar screen 45 includes a calendar display area 451 and scroll buttons 452A and 452B. The calendar display area 451 is an area for displaying a calendar corresponding to a designated month. The scroll buttons 452A and 452B are buttons for instructing the scroll of a monthly calendar which is displayed.

The calendar display module 232 displays the calendar screen 45 including a calendar of a predetermined month (e.g. a calendar corresponding to the present date). For example, when the present date is “October 1”, the calendar display module 232 displays the calendar screen 45 including the calendar of “October”.

The user selects a date, which is to be set to the anniversary, by using the calendar screen 45. The calendar display module 232 outputs the information indicative of the selected date (e.g. “October 27”) to the anniversary setting module 231 and image list display module 233. The user can also instruct the display of a calendar of the previous month or the next month by pressing the scroll button 452A or 452B. In response to the pressing of the scroll button 452A, the calendar display module 232 displays the calendar of the month, which precedes the month of the currently displayed calendar, in the calendar display area 451. In addition, in response to the pressing of the scroll button 452B, the calendar display module 232 displays the calendar of the month, which follows the month of the currently displayed calendar, in the calendar display area 451.

Based on the information indicative of the date which has been output by the calendar display module 232, the image list display module 233 displays a photo selection screen 46 including a list of images (thumbnail images) having the date information corresponding to this date. For example, when the date “October 27” has been output by the calendar display module 232, the image list display module 233 extracts those still images from the still images 51 stored in the content database 301, which have date information of “October 27” or date information near the date of “October 27”. Then, the image list display module 233 displays a list of thumbnail images indicative of the extracted still images in an image list display area 461. The list of the thumbnail images indicative of the extracted still images is displayed, for example, on a year-by-year basis. For example, the image list display area 461 (photo selection screen 46) of FIG. 8 displays a list of images having the date information of “Oct. 27, 2009” and “Oct. 26, 2009”.

The user selects an image, which is to be associated with the anniversary, by using the photo selection screen 46. Specifically, the user selects an image 461A, which is to be associated with the anniversary, from among a plurality of images displayed in the image list display area 461. The selected image is an image which is representative of the anniversary, for instance, a photo including the main character of the anniversary. After selecting the single image 461A which is to be associated with the anniversary, the user instructs the completion of the image selection by pressing an “OK” button 462. In response to the pressing of the “OK” button 462, the image list display module 233 outputs an image ID corresponding to the selected still image 461A to the anniversary setting module 231.

Based on the image ID which has been output by the image list display module 233, the anniversary setting module 231 previews the selected image in the photo display area 413. After inputting necessary information for setting the anniversary by using the anniversary setting screen 41, the user instructs the completion of the input by pressing the “OK” button 416. In response to the pressing of the “OK” button 416, the anniversary setting module 231 generates anniversary data 303A based on the input information. Specifically, the anniversary setting module 231 generates anniversary data 303A including the anniversary title which has been input to the anniversary title input area 411, the date of the anniversary which has been input to the anniversary input area 412, and the still image 461A (image ID) which has been associated with the anniversary. Thereby, the still image 461A, which has been selected by the user, is associated with the anniversary. The anniversary setting module 231 stores the generated anniversary data 303A in the anniversary database 303.

By the above-described structure, the anniversary setting control module 23 can store the anniversary data 303A, which is indicative of the anniversary, in the anniversary database 303. The anniversary setting control module 23 can set the anniversary, based on the information which has been input by the user. In the meantime, the anniversary setting control module 23 may store anniversary data 303A without the anniversary title in the anniversary database 303. The anniversary setting control module 23 may store anniversary data 303A which includes the date of the anniversary and the main character (person ID) of the anniversary. Besides, the anniversary setting control module 23 may store anniversary data 303A which includes an attribute of the anniversary which is designated by the user. For example, a keyword representative of the kind of the anniversary, such as “birthday” or “wedding anniversary”, or a keyword representative of the atmosphere of the anniversary, such as “happy” or “fantasy”, is set as the attribute of the anniversary.

The playback control module 24 plays back a moving picture which is suited to the anniversary based on the anniversary data 303A within a predetermined time period including the anniversary. The playback control module 24 generates a moving picture (photo-movie or slideshow) using still images 51 that are suited to the anniversary, by using the index information 302A. The playback control module 24 extracts still images which are relevant to a still image (key image) of a certain anniversary, from the still images 51 in the content database 301 based on the index information 302A. The playback control module 24 then creates and plays back a photo-movie or slideshow by using the extracted still images and the key image. The playback control module 24 includes, for example, a date determination module 241, an image extraction module 242, a moving picture generation module 243, and a moving picture playback module 244.

The date determination module 241 determines whether the present date is within a predetermined time period including the anniversary. Specifically, the date determination module 241 reads the anniversary data 303A stored in the anniversary database 303. Then, the date determination module 241 determines whether the present date is within a predetermined time period including the anniversary included in the anniversary data 303A. When the present date is within the predetermined time period including the anniversary, the date determination module 241 notifies the image extraction module 242 of the start of the process. In addition, the date determination module 241 outputs the information indicating whether the present date is the date of the anniversary, the date of a day preceding the anniversary within the predetermined time period, or the date of a day following the anniversary within the predetermined time period, to the moving picture generation module 243.

In response to the notification of the start of the process from the date determination module 241, the image extraction module 242 extracts images, which are relevant to the image associated with the anniversary of interest, from the content database 301. The image associated with the anniversary is also referred to as a key image or an extraction key. The image extraction module 242 extracts still images, which are relevant to the key image with respect to the date/time, location, person, etc., from the still images 51 stored in the content database 301. The extracted images are used for a moving picture (photo-movie or slideshow) which is to be played back. In addition, the image extraction module 242 may extract still images, which are relevant to a person (main character) who is associated with the anniversary of interest. The person associated with the anniversary is also referred to as a key person. In this case, the image extraction module 242 extracts still images 51, which are relevant to the key person who is associated with the anniversary, from the still images 51 stored in the content database 301.

The image extraction module 242 selects still images relevant to the key image, from the still images 51 stored in the content database 301. The still images relevant to the key image are, for example, still images having relevance to the key image with respect to the date/time, person or location. The image extraction module 242 selects the still images relevant to the key image, for example, by using the index information 302A stored in the content information database 302.

To be more specific, the image extraction module 242 selects still images having the date/time of generation which is relevant to the date/time of generation of the key image, from the still images 51 stored in the content database 301. For example, based on the index information 302A, the image extraction module 242 selects still images which were generated within the same time period (the time period designated by, e.g. a day, a month, a time of year, a season, or a year) as the date/time of generation of the key image. Thereby, for example, still images, which were photographed in the same event as the key image, are selected. In addition, for example, based on the index information 302A, the image extraction module 242 selects still images which were generated during the same day, the same week, the same month, etc. (e.g. the same day of the previous year, or the same month two years later) during a time period different from the date/time of generation of the key image.

In addition, the image extraction module 242 selects still images which are relevant to a person included in an image (key image) associated with the anniversary, from the still images 51 stored in the content database 301. For example, the image extraction module 242 selects still images including a face image of a person included in the key image. Besides, the image extraction module 242 selects still images which are relevant to a person (main character) associated with the anniversary. The image extraction module 242 selects still images including a face image of a main character. Besides, the image extraction module 242 may select still images including a face image of a person resembling main character or the person included in the key image. The still images including a face image of a person resembling the main character are selected, for example, by using a clustering result by the clustering module 222.

In the meantime, at the time of selecting still images, the image extraction module 242 may preferentially select an image in which at least one of the smile degree, sharpness and frontality is high, or an image with a large size, by using the index information 302A.

Furthermore, the image extraction module 242 may select still images which were generated at the location of generation that is relevant to the location of generation of the key image, from the still images 51 stored in the content database 301. For example, the image extraction module 242 selects still images, which were generated at the same location as the location of generation of the key image, from the content database 301. Specifically, the image extraction module 242 selects, for example, another photo (still image) which was taken at a sightseeing spot at which the key image was generated, from the content database 301. In the meantime, the image extraction module 242 may further narrow down the still images, which are to be selected, by combining the selections of still images based on the date/time, person and location. In addition, the condition for selecting still images may be changed according to whether the moving picture to be generated is a photo-movie or a slideshow.

The image extraction module 242 may change the still images which are extracted, according to whether the present date is the anniversary, a day preceding the anniversary within the predetermined time period, or a day following the anniversary within the predetermined time period. For example, when the present date is a day preceding the anniversary, the image extraction module 242 extracts still images having the date information (month/day) before the anniversary. When the present date is the anniversary, the image extraction module 242 extracts still images having the date information of the anniversary. When the present date is a day following the anniversary, the image extraction module 242 extracts still images having the date information after the anniversary.

For example, if the year of the anniversary, as well as the month/day of the anniversary, is set, when the present date is before the anniversary, the image extraction module 242 extracts still images having the date information (year/month/day) before the year/month/day of the anniversary. When the present date is the anniversary (i.e. the same date as the anniversary), the image extraction module 242 extracts still images having the date information of the year/month/day of the anniversary. When the present date is after the anniversary, the image extraction module 242 extracts still images having the date information (year/month/day) after the year/month/day of the anniversary.

The image extraction module 242 outputs the still image associated with the anniversary and the extracted still images to the moving picture generation module 243.

The moving picture generation module 243 generates a moving picture, such as a photo-movie or a slideshow, by using the still images output by the image extraction module 242, based on the information output by the date determination module 241. The information output by the date determination module indicates whether the present date is the anniversary, a day preceding the anniversary within the predetermined time period, or a day following the anniversary within the predetermined time period. The moving picture generation module 243 displays a moving picture which differs with respect to at least one of the length of the moving picture, the structure of still images used in the moving picture, and the effect used in the moving picture, for example, on a day-by-day basis within the predetermined time period. For example, according to whether the present date is the anniversary, a day preceding the anniversary within the predetermined time period, or a day following the anniversary within the predetermined time period, the moving picture generation module 243 creates a moving picture by changing the mode between a slideshow or a photo-movie, or by changing the length (playback time) of the moving picture, the still images used in the moving picture, the effect (transition) used in the moving picture, etc.

Specifically, when the present date is the anniversary, the moving picture generation module 243 generates a moving picture for the anniversary. In the moving picture for the anniversary, for example, still images having the date information of the anniversary are preferentially used from among the extracted still images. In addition, the image, which is associated with the anniversary, is used, for example, for a climax scene in the moving picture for the anniversary. The climax scene is, for example, the last scene included in the moving picture, or a scene in which a high visual effect is used. In the meantime, the moving picture for the anniversary may have a longer playback time than a moving picture which is played back in days other than the anniversary within the above-described predetermined time period. Besides, the moving picture generation module 243 can generate a moving picture having an effect of making the anniversary enjoyable and exciting, by using an effect or music (audio) for the anniversary, which is different from the effect or music used in a moving picture played back in days other than the anniversary. The moving picture generation module 243 may select the effect (transition) for use in the moving picture, for example, based on the attribute which is set in the anniversary data 301A. For example, when “birthday” is set to be the attribute of the anniversary, the moving picture generation module 243 creates a moving picture by using the effect which is suited to the “birthday”.

When the present date is in a period preceding the anniversary within the predetermined time period, the moving picture generation module 243 generates a moving picture for the period preceding the anniversary. In the moving picture for the period preceding the anniversary, for example, still images having the date information corresponding to the period preceding the anniversary are preferentially used from among the extracted still images. The moving picture for the period preceding the anniversary may have a shorter playback time than the moving picture that is played back in the anniversary. The moving picture for the period preceding the anniversary has an effect of, for example, notifying in advance the user that the anniversary is drawing near.

When the present date is in a period following the anniversary within the predetermined time period, the moving picture generation module 243 generates a moving picture for the period following the anniversary. In the moving picture for the period following the anniversary, for example, still images having the date information corresponding to the period following the anniversary are preferentially used from among the extracted still images. The moving picture for the period following the anniversary may have a shorter playback time than the moving picture that is played back in the anniversary.

The moving picture generation module 243 outputs the generated moving picture to the moving picture playback module 244.

The moving picture playback module 244 displays the moving picture on the screen (LCD 17) by playing back the moving picture output by the moving picture generation module 243.

By the above-described structure, the photo-movie creation application 202 can present the moving picture including still images which are suited to the anniversary to the user. The image extraction module 242 selects still images, which are relevant to one still image (key image) associated with the anniversary, from the still images 51 stored in the content database 301. The still images, which are relevant to the key image, are still images which are relevant to the key image with at least one of the date/time of generation of the key image, the location of generation of the key image and the person appearing in the key image. In the photo-movie creation application 202, still images satisfying a condition, such as the designated date/time of generation, are not selected, but still images having relevance to the key image are selected. Thereby, still images, which the user is unaware of, can also be selected. If a moving picture is created by selecting groups including still images based on the date/time of generation, the location of generation, etc. (e.g. still images stored in a directory associated with each day of generation), only a moving picture using the still images belonging to the group can be created. However, in the photo-movie creation application 202 of the embodiment, it is possible to select still images which do not belong to the same group (based on the date/time of generation) as a group to which the key image belongs, but which have relevance to the key image. Thereby, it is possible to reduce the time for selecting still images by the user, and to create the moving picture using the still images which are relevant to the anniversary.

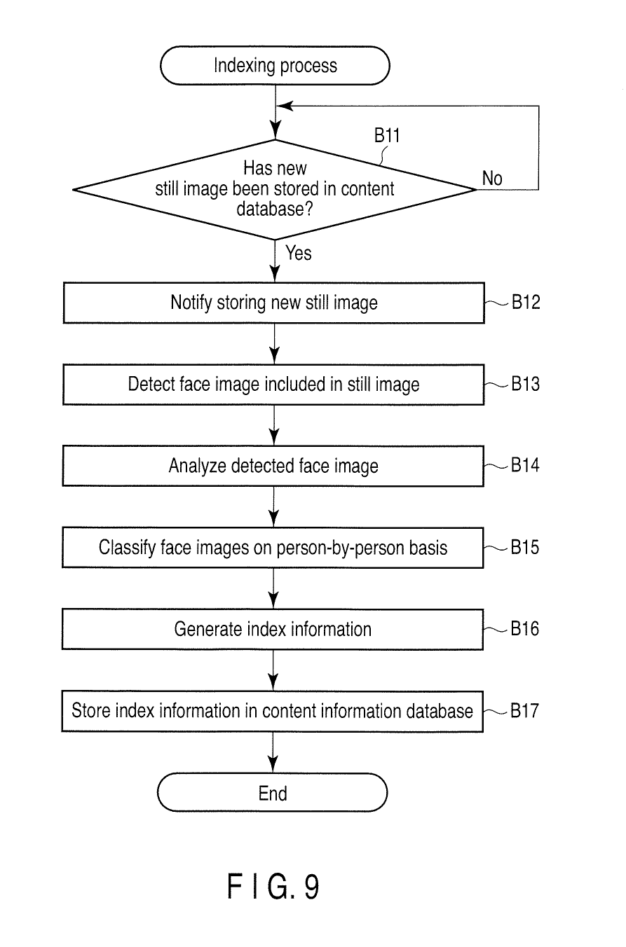

Next, referring to a flowchart of FIG. 9, a description is given of an example of the procedure of an indexing process which is executed by the photo-movie creation application program 202.

To start with, the monitor module 21 determines whether a new still image (still image data) 51 has been stored in the content database 301 in the HDD 109 by monitoring the content database 301 (block B11). If no new still image is stored (NO in block B11), the monitor module 21 determines once again whether a new still image 51 has been stored by returning to block B11.

If a new still image 51 is stored (YES in block B11), the monitor module 21 notifies the indexing module 22 that the new still image 51 has been stored in the content database 301 (block B12).

Then, the face image detection module 221 detects a face image included in the still image 51 (block B13). The face image detection module 221 detects a region corresponding to the face image of a person appearing in the still image 51, and then detects the position and size of the region in the still image. The face image detection module 221 analyzes the detected face image (block B14). The face image detection module 221 calculates, for example, the smile degree, sharpness, frontality, etc. of the detected face image. The face image detection module 221 outputs the information indicative of the detected face image to the clustering module 222.

The clustering module 222 classifies the detected face image(s) on a person-by-person basis by subjecting the detected face image to a clustering process (block B15). The clustering module 222 allocates the identification information (person ID) of the corresponding person to the face image. The clustering module 222 outputs the information indicative of the face image and the person ID allocated to the face image to the index information generation module 223.

The index information generation module 223 generates the index information 302A, based on the processing results by the face image detection module 221 and clustering module 222 (block B16). The index information 302A includes the date/time of generation of the still image 51, the location of generation of the still image 51, and the face image information indicative of the face image included in the still image 51. The face image information includes, for example, a face image (e.g. the location of storage of data corresponding to the face image), person ID, position, size, smile degree, sharpness, and frontality. When a plurality of face images are included in the still image 51, the index information 302A includes a plurality of face image information items corresponding to the plurality of face images. The index information generation module 223 stores the generated index information 302A in the content information database 302 (block B17).

By the above-described process, the indexing module 22 stores the index information 302A (the entry of index information 302A) corresponding to the still image 51, which has newly been stored in the content database 301, in the content information database 302.

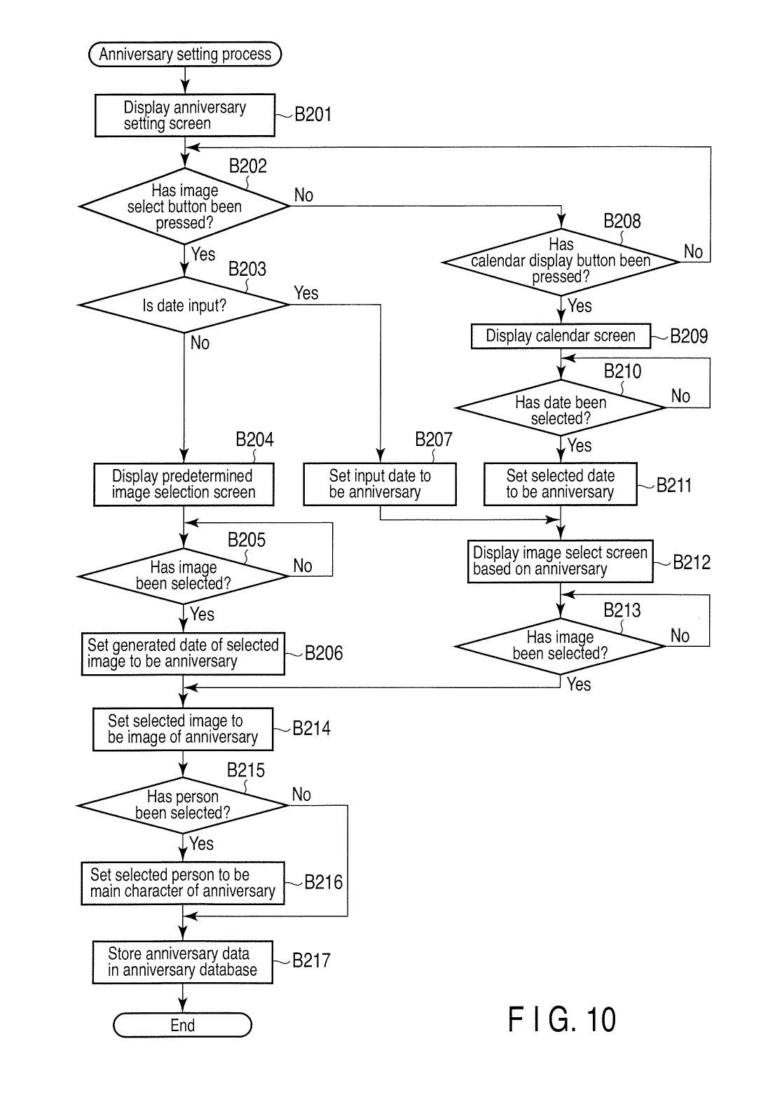

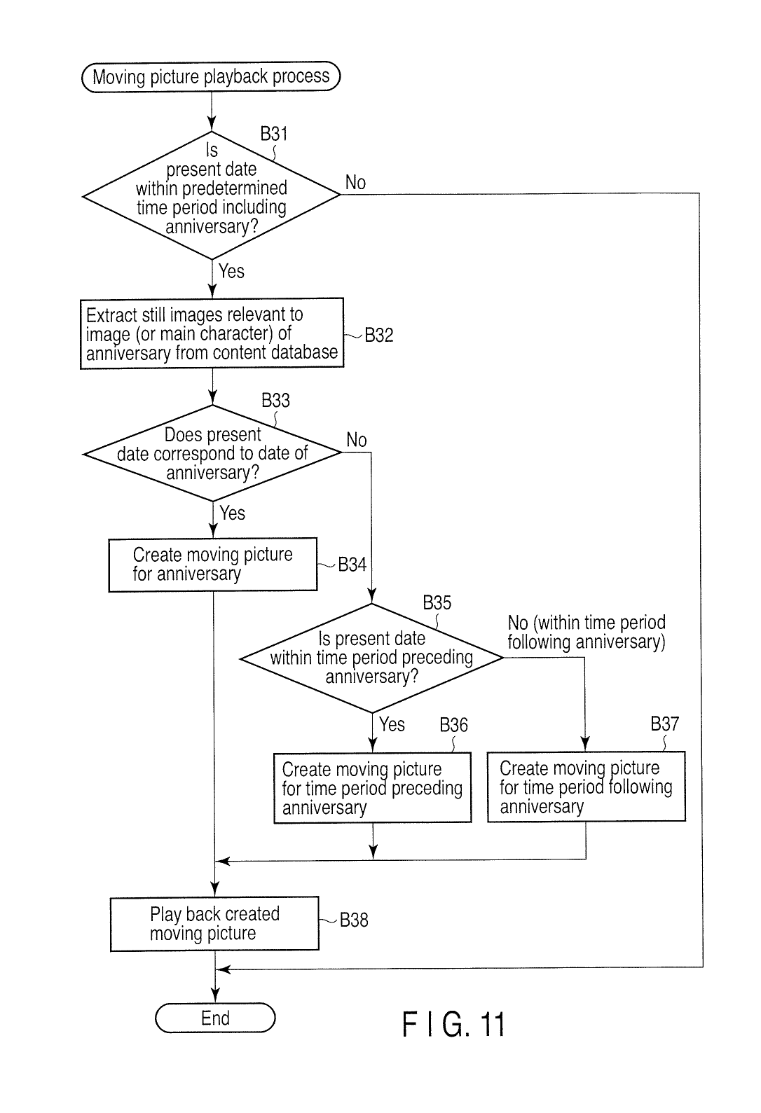

A flowchart of FIG. 10 illustrates an example of the procedure of an anniversary setting process which is executed by the photo-movie creation application program 202.

To start with, the anniversary setting module 231 displays the anniversary setting screen 41 (block B201). Then, the anniversary setting module 231 determines whether the image selection button 414 on the anniversary setting screen 41 has been pressed (block B202). If the image selection button 414 has been pressed (YES in block B202), the anniversary setting module 231 determines whether a date is input to the anniversary input area 412 (block B203).

If a date is input to the anniversary input area 412 (YES in block B203), the anniversary setting module 231 sets the input date to be the anniversary (block B207).

On the other hand, if a date is not input to the anniversary input area 412 (NO in block B203), the image list display module 233 displays a predetermined image select screen (block B204). The predetermined image select screen is, for example, a screen including a list of images having date/time information of generation near the present date. Then, the anniversary setting module 231 determines whether an image has been selected by using the image select screen which is displayed (block B205). If an image is selected (YES in block B205), the anniversary setting module 231 sets the date of generation of the selected image to be the anniversary (block B206). If an image is not selected (NO in block B205), the anniversary setting module 231 determines once again whether an image has been selected by returning to block B205.

If the image selection button 414 has not been pressed (NO in block B202), the anniversary setting module 231 determines whether the calendar display button 415 has been pressed (block B208). If the calendar display button 415 has not been pressed (NO in block B208), the anniversary setting module 231 determines once again whether the image selection button 414 has been pressed by returning to block B202.

If the calendar display button 415 has been pressed (YES in block B208), the calendar display module 232 displays the calendar screen 45 (block B209). Then, the anniversary setting module 231 determines whether a date has been selected by using the calendar screen 45 (block B210). If a date has not been selected by using the calendar screen 45 (NO in block B210), the anniversary setting module 231 determines once again whether a date has been selected by returning to block B210. If a date has been selected by using the calendar screen 45 (YES in block B210), the anniversary setting module 231 sets the selected date to be the anniversary (block B211).

After the anniversary has been set in block B207 or in block B211, the image list display module 233 displays the image select screen 42, 46, which is based on the set anniversary (block B212). Then, the anniversary setting module 231 determines whether an image has been selected by using the image select screen 42, 46 (block B213). If an image has not been selected by using the image select screen 42, 46 (NO in block B213), the anniversary setting module 231 determines once again whether an image has been selected by returning to block B213.

If an image has been selected (YES in block B213) or after the anniversary has been set in block B206, the anniversary setting module 231 sets the selected image to be the image of the anniversary (block B214). In other words, the anniversary setting module 231 associates the selected image with the anniversary. Then, the anniversary setting module 231 determines whether a person has been selected or not (block B215). The person is selected from persons included in the image which has been set to be the image of the anniversary. For example, the user performs an operation of designating a person of interest of the anniversary, from among the persons in the selected image. Thereby, the person is selected. Alternatively, a list of face images of persons appearing in the still image data 51 stored in the content database 301 may be displayed, and the user may select a person from the list.

When a person has been selected (YES in block B215), the anniversary setting module 231 sets the selected person to be the main character of the anniversary (block B216). In other words, the anniversary setting module 231 associates the selected person with the anniversary. If a person is not selected (NO in block B215), the anniversary setting module 231 does not set the main character.

The anniversary setting module 231 stores in the anniversary database 303 the anniversary data 303A including the date of the set anniversary, the image of the anniversary, and the information of the main character of the anniversary (block B217). If the main character is not set, the anniversary setting module 231 stores in the anniversary database 303 the anniversary data 303A including the date of the set anniversary and the image of the anniversary.

By the above-described process, the anniversary setting control module 23 stores the anniversary data 303A corresponding to the newly set anniversary in the anniversary database 303. The anniversary data 303A includes, in addition to the date of the anniversary, the image (photo) of the anniversary which has been selected by the user, and the information indicative of the main character of the anniversary.

Next, referring to a flowchart of FIG. 11, a description is given of an example of the procedure of a moving picture playback process which is executed by the photo-movie creation application program 202.

Using the anniversary data 303A, the playback control module 24 creates and plays back a moving picture (e.g. photo-movie or slideshow) which is suited to an anniversary, when the present date is within a predetermined time period including the anniversary.

To start with, the date determination module 241 determines whether the present date is within a predetermined time period including the anniversary (block B31). The date determination module 241 reads the anniversary data 303A in the anniversary database 303, and determines whether the present date is within a predetermined time period including the anniversary which is indicated in the anniversary data 303A. If the present date is not within the predetermined time period including the anniversary (NO in block B31), the moving picture playback process is finished (i.e. a moving picture based on the anniversary is not created or played back).

If the present date is within the predetermined time period including the anniversary indicated in the anniversary data 303A (YES in block B31), the image extraction module 242 extracts images, which are relevant to the image associated with the anniversary (and/or images which are relevant to the main character), from the content database 301 (block B32). The image extraction module 242 extracts still images, which are relevant, with respect to the date/time, location, person, etc., to the still image of the anniversary, from the still images 51 stored in the content database 301. The image extraction module 242 may extract images which are relevant to the main character of the anniversary.

Then, the date determination module 241 determines whether the present date coincides with the date of the anniversary (block B33). If the present date coincides with the date of the anniversary (YES in block B33), the moving picture generation module 243 creates a moving picture for the anniversary (block B34). In the moving picture for the anniversary, for example, still images having the date information of the anniversary are preferentially used from among the still images extracted in block B32. In addition, the photo, which is associated with the anniversary, is used, for example, for a climax scene in the moving picture for the anniversary. The moving picture for the anniversary may have a longer playback time than a moving picture which is played back in days other than the anniversary within the above-described predetermined time period. Besides, the moving picture generation module 243 can generate a moving picture having an effect of making the anniversary enjoyable and exciting, by using an effect or music for the anniversary, which is different from the effect or music used in a moving picture played back in days other than the anniversary.

If the present date does not coincide with the date of the anniversary (NO in block B33), the date determination module 241 determines whether the present date is within a period preceding the date of the anniversary (block B35). If the present date is within a period preceding the date of the anniversary (YES in block B35), the moving picture generation module 243 generates a moving picture for the period preceding the anniversary (block B36). In the moving picture for the period preceding the anniversary, for example, still images having the date information corresponding to the period preceding the anniversary are preferentially used from among the still images extracted in block B32. The moving picture for the period preceding the anniversary may have a shorter playback time than the moving picture that is played back in the anniversary. The moving picture for the period preceding the anniversary has an effect of, for example, notifying the user that the anniversary is drawing near.

If the present date is not within a period preceding the date of the anniversary (NO in block B35), that is, if the present date is within a period following the date of the anniversary, the moving picture generation module 243 generates a moving picture for the period following the anniversary (block B37). In the moving picture for the period following the anniversary, for example, still images having the date information corresponding to the period following the anniversary are preferentially used from among the still images extracted in block B32. The moving picture for the period following the anniversary may have a shorter playback time than the moving picture that is played back in the anniversary.

The moving picture playback module 244 displays the moving picture on the screen (LCD 17) by playing back the moving picture which has been created by the moving picture generation module 243 (block B38).

By the above-described process, the playback control module 24 can generate a moving picture which is suited to the present date based on the anniversary data 303A, and can present the moving picture to the user. By viewing (appreciating) the presented moving picture, the user can recognize the anniversary or can bring it to mind.

As has been described above, according to the present embodiment, the moving picture including still images, which are suited to the anniversary, can be presented to the user. The image extraction module 242 selects, from the still images 51 stored in the content database 301, still images which are relevant to one still image (key image) associated with the anniversary, or still images which are relevant to the person (main character) of the anniversary. When the present date is within a predetermined time period including the anniversary, the moving picture generation module 243 can generate a moving picture which is suited to the anniversary, by using a single still image associated with the anniversary, and still images relevant to the single still image. Thereby, when the pre-registered anniversary draws near, a slideshow or a photo-movie using the still images relevant to the anniversary can be presented to the user.

All the procedures of the indexing process, anniversary setting process and moving picture playback process in this embodiment may be executed by software. Thus, the same advantageous effects as with the present embodiment can easily be obtained simply by installing a program, which executes the procedures of the indexing process, anniversary setting process and moving picture playback process, into an ordinary computer through a computer-readable storage medium which stores the program, and executing this program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a specific date setting module configured to set an input date to be a specific date;
an image setting module configured to associate one still image with the specific date, the associated still image being designated by a user;
an image extraction module configured to extract still images from a plurality of still images when a present date is within a first time period comprising the specific date, the extracted still images comprising at least a still image which is relevant to the date and time when the associated still image is generated and a place where the associated still image is generated; and
an image display module configured to display a moving picture using the extracted still images, the moving picture being different with respect to at least one of a length of the moving picture, a combination of still images used in the moving picture, and an effect used in the moving picture, on a day-by-day basis within the first time period.

2. The electronic apparatus of claim 1, further comprising a person setting module configured to associate a person with the specific date, the associated person being selected from persons appearing in the associated still image by the user,
wherein the image extraction module is configured to extract another still image from the plurality of still images, the extracted another still image being relevant to the associated person.

3. The electronic apparatus of claim 1, wherein the image display module is configured to display the moving picture using the extracted still images according to whether the present date is the specific date, a day preceding the specific date within the first time period, or a day following the specific date within the first time period.

4. The electronic apparatus of claim 1, wherein the image setting module is configured to display a list of still images of the plurality of still images, which have date information corresponding to the specific date, the associated still image being selected from the still images in the list by the user.

5. An electronic apparatus comprising:
a specific date setting module configured to set an input date to be a specific date;
a person setting module configured to display a list of face images corresponding to persons which appear in a plurality of still images and to associate one person with the specific date, the associated person corresponding to a face image selected from the face images in the list by a user;
an image extraction module configured to extract still images from the plurality of still images when a present date is within a first time period including the specific date, the extracted still images being relevant to the associated person; and
an image display module configured to display a moving picture using the extracted still images, the moving picture being different with respect to at least one of a length of the moving picture, a combination of still images used in the moving picture, and an effect used in the moving picture, on a day-by-day basis within the first time period.

6. The electronic apparatus of claim 5, wherein the image display module is configured to display the moving picture using the extracted still images according to whether the present date is the specific date, a day preceding the specific date within the first time period, or a day following the specific date within the first time period.

7. An image processing method comprising:
setting an input date to be a specific date by a specific date setting module;
associating one still image with the specific date by an image setting module, the associated still image being designated by a user;
extracting still images from a plurality of still images by an image extraction module when a present date is within a first time period comprising the specific date, the extracted still images comprising at least a still image which is relevant to the date and time when the associated still image is generated and a place where the associated still image is generated; and
displaying a moving picture using the extracted still images, the moving picture being different with respect to at least one of a length of the moving picture, a combination of still images used in the moving picture, and an effect used in the moving picture, on a day-by-day basis within the first time period by an image display module.

8. A non-transitory computer readable medium implemented within a computer and having stored thereon a program that, when executed by a processor within the computer, causes the computer to:
set an input date to be a specific date;
associate one still image with the specific date, the associated still image being designated by a user;
extract still images from a plurality of still images when a present date is within a first time period comprising the specific date, the extracted still images comprising at least a still image which is relevant to the date and time when the associated still image is generated and a place where the associated still image is generated; and
display a moving picture using the extracted still images, the moving picture being different with respect to at least one of a length of the moving picture, a combination of still images used in the moving picture, and an effect used in the moving picture, on a day-by-day basis within the first time period.
